(19) United States
(12) Patent Application Publication
(10) Pub. No.: US 2025/0142687 A1
(43) Pub. Date: May 1, 2025

(54) ELECTRONIC APPARATUS FOR IDENTIFYING TYPE OF CONTAINER AND CONTROLLING METHOD THEREOF

(71) Applicant: SAMSUNG ELECTRONICS CO., LTD., Sunwon-si (KR)

(72) Inventors: Mindo ROH, Suwon-si (KR); Keehwan KA, Suwon-si (KR); Seongjoo HAN, Suwon-si (KR)

(73) Assignee: SAMSUNG ELECTRONICS CO., LTD., Sunwon-si (KR)

(21) Appl. No.: 18/966,644

(22) Filed: Dec. 3, 2024

Related U.S. Application Data
(63) Continuation of application No. PCT/KR2024/014807, filed on Sep. 27, 2024.

(30) Foreign Application Priority Data
Oct. 30, 2023 (KR) 10-2023-0147002

(51) Int. Cl. H05B 6/64; H05B 6/66

(52) U.S. Cl. CPC H05B 6/6455; H05B 6/6482; H05B 6/668

(57) ABSTRACT

An electronic apparatus includes a microwave generating device, a thermal imaging camera, one or more processors, and memory storing instructions that, when executed by the one or more processors, cause the electronic apparatus to: control the microwave generating device to output microwaves into a cavity; obtain a first temperature pattern, based on first thermal images obtained through the thermal imaging camera, based on the microwaves not being output; obtain a second temperature pattern, based on second thermal images obtained through the thermal imaging camera, based on the microwaves not being output; obtain temperature pattern information including information about whether the microwaves are output, the first temperature pattern, and the second temperature pattern; identify a type of a container by inputting the temperature pattern information to a first neural network model; and output a notification based on the type of the container.

### CROSS-REFERENCE TO RELATED APPLICATIONS

This application is a by-pass continuation application of International Application No. PCT/KR2024/014807, filed on Sep. 27, 2024, which is based on and claims priority to Korean Patent Application No. 10-2023-0147002, filed on Oct. 30, 2023, in the Korean Intellectual Property Office, the disclosures of which are incorporated by reference herein in their entireties.

### BACKGROUND

### 1. Field

The disclosure relates to an electronic apparatus and a controlling method thereof, and in particular, to an electronic apparatus for identifying a type of container and a controlling method thereof.

### 2. Description of Related Art

With the development of electronic technology, various types of electronic apparatuses are being developed. In particular, various electronic apparatuses may increase user convenience.

However, cooking devices may rely on the user's arbitrary judgment in applying information about unusable containers or information about food, for example.

Accordingly, if a user uses an inappropriate container, there could be a problem of fire or hazardous substances being generated in the cooking device.

### SUMMARY

Provided is an electronic apparatus and a controlling method thereof, capable of identifying a type of a container.

According to an aspect of the disclosure, an electronic apparatus includes a microwave generating device, a thermal imaging camera, one or more processors; and memory storing instructions that, when executed by the one or more processors, cause the electronic apparatus to: control the microwave generating device to output microwaves into a cavity that is an internal space of the electronic apparatus; obtain a first temperature pattern, based on a plurality of first thermal images obtained through the thermal imaging camera, based on the microwaves are output; obtain a second temperature pattern, based on a plurality of second thermal images obtained through the thermal imaging camera, based on the microwaves are not output; obtain temperature pattern information including information about whether the microwaves are output, the first temperature pattern, and the second temperature pattern; identify a type of a container by inputting the temperature pattern information to a first neural network model; and output a first usage notification regarding the electronic apparatus based on the type of the container.

The one or more processors may be configured to execute the instructions to cause the electronic apparatus to obtain the temperature pattern information at preset time intervals, obtain a plurality of probability values corresponding to a plurality of types of container respectively by inputting the temperature pattern information obtained at the preset time intervals to the first neural network model, and, based on a largest probability value of the plurality of probability values being equal to or greater than a preset value, identify a first type corresponding to the largest probability value as the type of the container.

The one or more processors may be configured to execute the instructions to cause the electronic apparatus to, based on the type of the container being a preset type of one or more preset types corresponding to one or more hazardous materials, output a notification indicating that the container is hazardous, and control the microwave generating device to stop outputting the microwaves; and, based on the type of the container not being the preset type, control the microwave generating device to keep outputting the microwaves.

The electronic apparatus may further include a display, and the one or more processors may be configured to execute the instructions to cause the electronic apparatus to identify a second type of a recommended container corresponding to an operation mode of the electronic apparatus; and, based on the type of the container being different from the second type, control the display to indicate the second type.

The electronic apparatus may further include a user interface, and the one or more processors may be configured to execute the instructions to cause the electronic apparatus to, based on a user command for controlling the electronic apparatus being received through the user interface, output the microwaves to the cavity by controlling the microwave generating device for a preset time at a preset output power level to identify the type of the container, prior to operating in response to the user command.

The one or more processors may be configured to execute the instructions to cause the electronic apparatus to identify the type of the container for the preset time; and, based on the type of the container not being a preset type of one or more preset types corresponding to one or more hazardous materials, control the microwave generating device based on an operation mode of the electronic apparatus corresponding to the user command.

The first neural network model may be trained based on first input data including a first plurality of temperature patterns and first output data including a plurality of types of containers.

The first input data may further include at least one of a plurality of ambient temperatures, a plurality of operation modes, or a plurality of output power levels.

The one or more processors may be configured to execute the instructions to cause the electronic apparatus to obtain the temperature pattern information from a second neural network model, and the second neural network model may be trained based on second input data including a plurality of thermal images and second output data including a second plurality of temperature patterns.

The electronic apparatus may further include a heater, and the one or more processors may be configured to execute the instructions to cause the electronic apparatus to, based on the type of the container being a second type unable to use the heater, output a second usage notification regarding the heater.

According to an aspect of the disclosure, a controlling method of an electronic apparatus, includes outputting microwaves into a cavity that is an internal space of the electronic apparatus by controlling a microwave generating device included in the electronic apparatus; obtaining a first temperature pattern, based on a plurality of first thermal images obtained through a thermal imaging camera included in the electronic apparatus, based on the microwaves are output; obtaining a second temperature pattern, based on a plurality of second thermal images obtained through the thermal imaging camera, based on the microwaves are not output; obtaining temperature pattern information including information about whether the microwaves are output, the first temperature pattern, and the second temperature pattern; identifying a type of a container by inputting the temperature pattern information to a first neural network model; and outputting a first usage notification regarding the electronic apparatus based on the type of the container.

The obtaining the temperature pattern information may include obtaining the temperature pattern information at preset time intervals; and the identifying the type of the container may include obtaining a plurality of probability values corresponding to a plurality of types of container respectively by inputting the temperature pattern information obtained at the preset time intervals to the first neural network model; and based on a largest probability value of the plurality of probability values being equal to or greater than a preset value, identifying a first type corresponding to the largest probability value as the type of the container.

The outputting the usage notification may include, based on the type of the container being a preset type of one or more preset types corresponding to one or more hazardous materials, outputting a notification indicating that the container is hazardous, and controlling the microwave generating device to stop outputting the microwaves; and based on the type of the container not being the preset type corresponding to a hazardous material, controlling the microwave generating device to keep outputting the microwaves.

The controlling method may further include identifying a second type of a recommended container corresponding to an operation mode of the electronic apparatus; and, based on the type of the container being different from the second type, indicating the second type.

The outputting the microwaves may include, based on a user command for controlling the electronic apparatus being received through a user interface, outputting the microwaves to the cavity by controlling the microwave generating device for a preset time at a preset output power level to identify the type of the container, prior to operating in response to the user command.

The identifying the type of the container may include identifying the type of the container for the preset time, and the controlling method may further include, based on the type of the container not being a preset type of one or more preset types corresponding to one or more hazardous materials, controlling the microwave generating device based on an operation mode of the electronic apparatus corresponding to the user command.

The first neural network model may be trained based on first input data including a first plurality of temperature patterns and first output data including a plurality of types of containers.

The first input data may further include at least one of a plurality of ambient temperatures, a plurality of operation modes, or a plurality of output power levels.

The controlling method may further include, based on the type of the container being a second type unable to use a heater, output a second usage notification regarding the heater.

According to an aspect of the disclosure, a non-transitory computer-readable recording medium having instructions recorded thereon, that, when executed by one or more processors, cause the one or more processors to control a microwave generating device to output microwaves into a cavity that is an internal space of an electronic apparatus; obtain a first temperature pattern, based on a plurality of first thermal images obtained through a thermal imaging camera, based on the microwaves are output; obtain a second temperature pattern, based on a plurality of second thermal images obtained through the thermal imaging camera, based on the microwaves are not output; obtain temperature pattern information including information about whether the microwaves are output, the first temperature pattern, and the second temperature pattern; identify a type of a container by inputting the temperature pattern information to a first neural network model; and output a first usage notification regarding the electronic apparatus based on the type of the container.

### BRIEF DESCRIPTION OF THE DRAWINGS

The above and other aspects, features, and advantages of certain embodiments of the disclosure are more apparent from the following description taken in conjunction with the accompanying drawings, in which:

FIG. 1 is a view provided to explain an electronic system according to an embodiment;

FIG. 2 is a block diagram illustrating configuration of an electronic apparatus according to an embodiment;

FIG. 3 is a block diagram illustrating detailed configuration of an electronic apparatus according to an embodiment;

FIGS. 4 and 5 are views provided to explain a temperature pattern in response to control of a microwave generating device according to an embodiment;

FIGS. 6 and 7 are views provided to explain a method of analyzing a thermal image according to an embodiment;

FIGS. 8 and 9 are views provided to explain a temperature pattern based on a type of container and output of a neural network model based on the temperature pattern according to an embodiment;

FIG. 10 is a view provided to explain an operation of outputting a notification indicating that a container is a hazardous material according to an embodiment;

FIG. 11 is a view provided to explain an operation of guiding efficiency of a container according to an embodiment;

FIG. 12 is a view provided to explain an operation of guiding a temperature of a container according to an embodiment;

FIG. 13 is a view provided to explain an operation based on a type of glass according to an embodiment; and

FIG. 14 is a flowchart provided to explain a controlling method of an electronic apparatus according to an embodiment.

### DETAILED DESCRIPTION

The embodiments described in the disclosure, and the configurations shown in the drawings, are only examples of embodiments, and various modifications may be made without departing from the scope and spirit of the disclosure.

The exemplary embodiments of the disclosure may be diversely modified. Accordingly, exemplary embodiments are illustrated in the drawings and are described in detail in the detailed description. However, it is to be understood that the disclosure is not limited to an exemplary embodiment, but includes all modifications, equivalents, and substitutions without departing from the scope and spirit of the disclosure.

The object of the disclosure is to provide an electronic apparatus that identifies a type of container based on temperature pattern information inside the electronic apparatus, and outputs a notification to a user based on the type of container, and a controlling method thereof.

Various embodiments in this disclosure and the terms used herein do not intend to limit the technical features in this disclosure to specific embodiments, but should be understood to include various modifications, equivalents or alternatives of the corresponding embodiments.

With respect to the description of the drawings, similar components may be denoted by similar reference numerals.

The singular form of a noun corresponding to an item may include one item or a plurality of items, unless the relevant context clearly indicates otherwise.

In this disclosure, “A or B”, “at least one of A and B”, “at least one of A or B”, “A, B or C”, “at least one of A, B and C”, and “at least one of A, B, or C” may each include any one of the items listed together in the corresponding phrase, or any possible combination thereof.

Terms “first”, “second”, “1^{st},” or “2^{nd}” may be used to distinguish the corresponding component from other corresponding components, and may limit the corresponding components in other aspects (e.g.: importance or order).

When it is mentioned that one (e.g., first) component is “coupled” or “connected” to another (e.g., second) component, with or without the terms “functionally” or “communicatively”, it means that the component can be connected to another component directly (e.g. wired), wirelessly, or through a third component.

Terms such as “have” or “include” are intended to designate the presence of features, numbers, steps, operations, components, parts, or a combination thereof described in this disclosure, but are not intended to exclude the presence or addition of one or more other features, numbers, steps, operations, components, parts, the existence or addition of steps, operations, components, parts, or a combination thereof in advance.

When a component is said to be “connected,” “coupled,” “supported,” or “in contact” with another component, this means not only when the components are directly connected, coupled, supported, or in contact, but also when they are indirectly connected, coupled, supported, or in contact through a third component.

When a component is said to be located “on” another component, this includes not only a case where a component is in contact with another component, but also a case where another component exists between the two components.

The term “and/or” includes a combination of a plurality of related elements described herein or any element of a plurality of related elements described herein.

Hereinafter, the operation principle of the disclosure and embodiments thereof will be described with reference to the accompanying drawings.

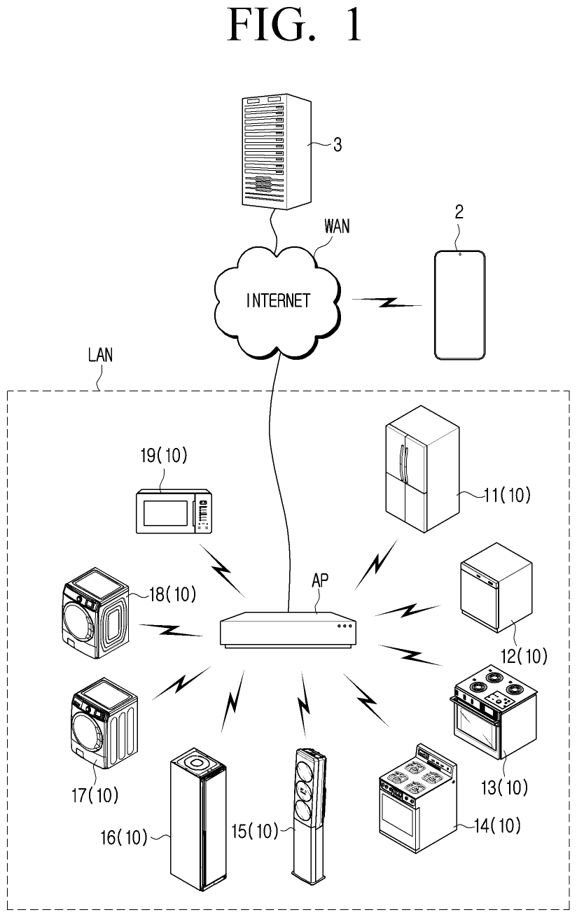

FIG. 1 is a view provided to explain an electronic system according to an embodiment.

A home appliance 10 may include a communication module capable of performing communication with other home appliances, a user device 2, or a server 3, a user interface for receiving a user input or outputting information to the user, at least one processor for controlling the operation of the home appliance 10, and at least one memory in which a program for controlling the operation of the home appliance 10 is stored.

The home appliance 10 may be at least one of various types of home appliances. For example, the home appliance 10 may include at least one of a refrigerator 11, a dishwasher 12, a microwave 13, an electric oven 14, an air conditioner 15, a garment care machine 16, a washing machine 17, a dryer 18, or a microwave oven 19, but is not limited thereto, and may include various other types of appliances, such as a cleaning robot, a vacuum cleaner, a television, for example. In addition, the aforementioned appliances are only examples, and in addition to the aforementioned appliances, any appliances that can be connected to other appliances, the user devices 2, or the server 3 to perform the operation described below may be included in the home appliance 10 according to an embodiment.

The server 3 may include a communication module capable of performing communication with other servers, the home appliances 10, or the user devices 2, at least one processor capable of processing data received from other servers, the home appliances 10, or the user devices 2, and at least one memory capable of storing a program for processing data or processed data. The server 3 may be implemented as various computing devices, such as a workstation, a cloud, a data drive, a data station, etc. The server 3 may be implemented as one or more servers that are physically or logically separated based on a function, detailed configuration of the function, data, etc. and may transmit and receive data and process the data transmitted and received through communication between servers.

The server 3 may manage user accounts, register the home appliances 10 in association with the user accounts, manage or control the registered home appliances 10, and the like. For example, a user may connect to the server 3 through the user device 2 and create a user account. The user account may be identified by a username and password set by the user. The server 3 may register the home appliance 10 to the user account according to a preset procedure. For example, the server 3 may connect identification information of the home appliance 10 (e.g., serial number or MAC address, etc.) to the user account and register, manage, and control the home appliance 10. The user device 2 may include a communication module capable of performing communication with the home appliance 10 or the server 3, a user interface for receiving a user input or outputting information to the user, at least one processor for controlling the operation of the user device 2, and at least one memory for storing a program for controlling the operation of the user device 2.

The user device 2 may be carried by the user, or may be placed in the user's home or office, or the like. The user device 2 may include, but is not limited to, a personal computer, a terminal, a portable telephone, a smart phone, a handheld device, a wearable device, and the like.

The memory of the user device 2 may store a program, for example, an application for controlling the home appliance 10. The application may be sold installed on the user device 2 or may be downloaded from an external server and installed.

By executing the application installed on the user device 2, the user may connect to the server 3 to create a user account, and perform communication with the server 3 based on the logged-in user account to register the home appliance 10.

For example, when the home appliance 10 is operated to allow the home appliance 10 to connect to the server 3 by following a procedure guided by the application installed on the user device 2, the server 3 may register the home appliance 10 with the user account by listing the identification information of the home appliance 10 (e.g., serial number or MAC address, etc.) in the corresponding user account.

The user may control the home appliance 10 using the application installed on the user device 2. For example, when the user logs into the user account with the application installed on the user device 2, the home appliance 10 registered in the user account appears, and when the user enters a control command for the home appliance 10, the control command can be delivered to the home appliance 10 through the server 3.

A network may include both wired and wireless networks. The wired network includes a cable network, a telephone network, etc., and the wireless network may include any network that transmits and receives signals through radio waves. The wired and wireless networks can be connected to each other.

The network may include a wide area network (WAN), such as the Internet, a local area network (LAN) formed around an access point (AP), and a near-field wireless network that does not go through an AP. The near-field wireless network may include, but is not limited to, Bluetooth™ (IEEE 802.15.1), Zigbee (IEEE 802.15.4), Wi-Fi Direct, Near Field Communication (NFC), Z-Wave, etc.

The access repeater (AP) may connect the home appliance 10 or the user device 2 to a wide area network (WAN) to which the server 3 is connected. The home appliance 10 or user device 2 may be connected to the server 3 through the wide area network (WAN).

The access repeater (AP) may perform communication with the home appliance 10 or the user device 2 using wireless communications such as Wi-Fi™ (IEEE 802.11), Bluetooth™ (IEEE 802.15.1), Zigbee (IEEE 802.15.4), etc., and may connect to a wide area network (WAN) using wired communication, but is not limited thereto.

According to various embodiments, the home appliance 10 may be directly connected to the user device 2 or the server 3 without going through an access repeater (AP).

The home appliance 10 may be connected to the user device 2 or the server 3 through a far-field wireless network or a near-field wireless network.

For example, the home appliance 10 may be connected to the user device 2 through a near-field wireless network (e.g., Wi-Fi Direct).

In another example, the home appliance 10 may be connected to the user device 2 or the server 3 through a wide area network (WAN) using a far-field wireless network (e.g., a cellular communication module).

In another example, the home appliance 10 may be connected to a wide area network (WAN) using wired communication, and may be connected to the user device 2 or the server 3 through the wide area network (WAN).

In the case where the home appliance 10 may connect to the wide area network (WAN) using wired communication, it may also act as an access repeater. Accordingly, the home appliance 10 may connect other home appliances to the wide area network (WAN) to which the server 3 is connected. In addition, other home appliances may connect the home appliance 10 to the wide area network (WAN) to which the server 3 is connected.

The home appliance 10 may transmit information about its operation or state to another home appliance, the user device 2, or the server 3 through a network. For example, when a request is received from the server 3 or when a certain event occurs on the home appliance 10, the home appliance 10 may transmit information about its operation or state to another home appliance, the user device 2, or the server 3 or periodically or in real time. When information about the operation or state is received from the home appliance 10, the server 3 may update the stored information about the operation or state of the home appliance 10 and transmit the updated information about the operation and state of the home appliance 10 to the user device 2 through the network. Here, updating the information may include various operations in which the existing information is changed, such as adding new information to the existing information, replacing the existing information with new information, etc.

The home appliance 10 may obtain various information from other home appliances, the user device 2, or the server 3, and may provide the obtained information to the user. For example, the home appliance 10 may obtain from the server 3 information related to functions of the home appliance 10 (e.g., recipes, laundry instructions, etc.), information about various environments (e.g., weather, temperature, humidity, etc.), and output the obtained information through a user interface.

The home appliance 10 may operate in response to a control command received from other home appliances, the user device 2, or the server 3. For example, when the home appliance 10 has obtained prior authorization from the user to operate in response to a control command from the server 3 even without a user input, the home appliance 10 may operate in response to a control command received from the server 3. Here, the control command received from the server 3 may include, but is not limited to, control commands entered by the user through the user device 2 or control commands based on preset conditions.

The user device 2 may transmit information about the user to the home appliance 10 or the server 3 through a communication module. For example, the user device 2 may transmit information about the user's location, the user's health status, the user's preferences, the user's schedule, etc. to the server 3. The user device 2 may transmit information about the user to the server 3 based on the user's prior authorization.

The home appliance 10, the user device 2, or the server 3 may determine a control command using a technology such as artificial intelligence. For example, the server 3 may receive information about the operation or state of the home appliance 10 or information about the user of the user device 2, process the information using a technology such as artificial intelligence, and transmit the processing results or control instructions to the home appliance 10 or the user device 2 based on the processing results.

Hereinafter, a home appliance such as the microwave 13, the electric oven 14, the microwave oven 19, and the like, which is capable of cooking food in a container among the home appliances 10 is described as an electronic apparatus 100.

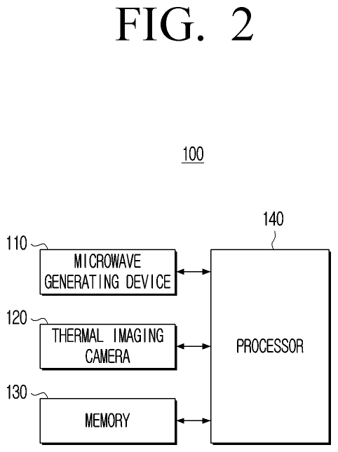

FIG. 2 is a block diagram illustrating configuration of the electronic apparatus 100 according to an embodiment.

The electronic apparatus 100 is a device that cooks food ingredients in a container, and may be a device that identifies the type of container. For example, the electronic apparatus 100 is a device that automatically cooks food ingredients in a container, and may be an oven, a microwave oven, an air fryer, a microwave, or a deep fryer. However, the electronic apparatus 100 is not limited thereto, and the electronic apparatus 100 may be any device capable of identifying the type of container.

Referring to FIG. 2, the electronic apparatus 100 includes a microwave generating device 110, a thermal imaging camera 120, a memory 130, and a processor 140.

The microwave generating device 110 may be a device that outputs microwaves. For example, the microwave generating device 110 may include a magnetron (MGT) that generates microwaves at 2.45 GHz. However, the microwave generating device 110 is not limited thereto, and the microwave generating device 110 may be any device capable of rotating polarized water molecules through electromagnetic waves, causing them to collide with other water molecules and generate heat.

The thermal imaging camera 120 may obtain a thermal image by visualizing infrared ray emitted by a subject. For example, the thermal imaging camera 120 may detect and image radiant heat emitted by an object having heat. In this case, the processor 140 may obtain a temperature pattern based on the thermal image.

However, the thermal imaging camera 120 is not limited thereto, and the thermal imaging camera 120 may obtain a thermal image by visualizing infrared ray emitted by the subject, and obtain a temperature pattern from the thermal image. In this case, the processor 140 may obtain the temperature pattern provided by the thermal imaging camera 120.

The memory 130 may refer to hardware that stores information, such as data, in an electrical or magnetic form for access by the processor 140 or the like. To this end, the memory 130 may be implemented as at least one of the following hardware: non-volatile memory, volatile memory, flash memory, hard disk drive (HDD) or solid state drive (SSD), RAM, ROM, etc.

The memory 130 may store at least one instruction for the operation of the electronic apparatus 100 or the processor 140. Here, the instruction is a code unit that instructs the operation of the electronic apparatus 100 or the processor 140, and may be written in machine language, a language that a computer can understand. The memory 130 may store a plurality of instructions for performing tasks of the electronic apparatus 100 or the processor 140 as an instruction set.

The memory 130 may store data which is information in the unit of bits or bytes that can represent letters, numbers, images, etc. For example, the memory 130 may store a neural network module, etc.

The memory 130 is accessed by the processor 140, and reading, writing, modifying, deleting, or updating of instructions, instruction sets, or data may be performed by the processor 140.

The processor 140 controls the overall operations of the electronic apparatus 100. The processor 140 may be connected to each configuration of the electronic apparatus 100 to control the overall operations of the electronic apparatus 100. For example, the processor 140 may be connected to the configuration such as the microwave generating device 110, the thermal imaging camera 120, the memory 130, the user interface, and the like to control the operations of the electronic apparatus 100.

At least one processor may include one or more of a central processing unit (CPU), a graphics processing unit (GPU), an accelerated processing unit (APU), a many integrated core (MIC), a neural processing unit (NPU), a hardware accelerator, or a machine learning accelerator. At least one processor may control one or any combination of other components of the electronic apparatus 100, and may perform operations related to communication or data processing. At least one processor may execute one or more programs or instructions stored in the memory 130. For example, at least one processor may perform a method according to an embodiment of the disclosure by executing one or more instructions stored in the memory 130.

In a case where the method according to an embodiment of the disclosure includes a plurality of operations, the plurality of operations may be performed by one processor or by a plurality of processors. For example, in a case where a first operation, a second operation, and a third operation are performed by the method according to an embodiment, all of the first operation, the second operation, and the third operation may be performed by a first processor, or the first operation and the second operation may be performed by the first processor and the third operation may be performed by a second processor (e.g., an artificial intelligence-dedicated processor).

At least one processor may be implemented as a single-core processor including one core, or may be implemented as one or more multi-core processors including a plurality of cores (e.g., homogeneous multiple cores or heterogeneous multiple cores). In a case where the at least one processor is implemented as multi-core processors, each of the plurality of cores included in the multi-core processors may include a processor internal memory such as a cache memory or an on-chip memory, and a common cache shared by the plurality of cores may be included in the multi-core processors. In addition, each of the plurality of cores (or some of the plurality of cores) included in the multi-core processors may independently read and execute program instructions for implementing the method according to an embodiment, or all (or some) of the plurality of cores may be linked to each other to read and execute program instructions for implementing the method according to an embodiment.

In a case where the method according to an embodiment includes a plurality of operations, the plurality of operations may be performed by one of the plurality of cores included in the multi-core processors, or may be performed by the plurality of cores. For example, in a case where a first operation, a second operation, and a third operation are performed by the method according to an embodiment, all of the first operation, the second operation, and the third operation may be performed by a first core included in the multi-core processors, or the first operation and the second operation may be performed by the first core included in the multi-core processors, and the third operation may be performed by a second core included in the multi-core processors.

In embodiments of the disclosure, at least one processor may refer to a system on a chip (SoC) in which one or more processors and other electronic components are integrated, a single-core processor, multi-core processors, or a core included in the single-core processor or the multi-core processors. Here, the core may be implemented as CPU, GPU, APU, MIC, NPU, hardware accelerator, machine learning accelerator, or the like, but the embodiments of the disclosure are not limited thereto. However, hereinafter, for convenience of explanation, the operation of the electronic apparatus 100 will be described with the expression of the processor 140.

The processor 140 may control the microwave generating device 110 to output microwaves to the cavity which is an internal space of the electronic apparatus 100, and obtain a first temperature pattern based on a plurality of first thermal images obtained through the thermal imaging camera 120 while outputting microwaves, obtain a second temperature pattern based on a plurality of second thermal images obtained through the thermal imaging camera 120 while not outputting microwaves, obtain temperature pattern information including information about whether the microwaves are output, the first temperature pattern and the second temperature pattern, identify a type of container by inputting the temperature pattern information into a neural network model, and output a usage notification regarding the electronic apparatus 100 based on the type of container.

The processor 140 may obtain the plurality of first thermal images through the thermal imaging camera 120 while outputting microwaves, obtain the plurality of second thermal images through the thermal imaging camera 120 while not outputting microwaves, and obtain the temperature pattern information including the first temperature pattern of the container obtained based on the plurality of first thermal images and the second temperature pattern of the container obtained based on the plurality of second thermal images. For example, the processor 140 may output microwaves for 30 seconds, not output microwaves for the immediately following 30 seconds, and repeat this for 5 minutes. The processor 140 may obtain six first thermal images through the thermal imaging camera 120 at 5-second intervals during the 30-second period of microwave output, and obtain six second thermal images through the thermal imaging camera 120 at 5-second intervals during the immediately following 30-second period of no microwave output. The processor 140 may identify a first temperature pattern of increasing temperature from the six first thermal images, identify a second temperature pattern of decreasing temperature from the six second thermal images, and obtain temperature pattern information for a one-minute period. The temperature pattern information may include the first temperature pattern while the microwaves are output and the second temperature pattern while the microwaves are not output. The temperature pattern information may not only include the first temperature pattern and the second temperature pattern, but may also include information that the first temperature pattern is a temperature pattern while the microwaves are output and the second temperature pattern is a temperature pattern while the microwaves are not output.

Hereinabove, it is described that the processor 140 obtains temperature pattern information for a period of one minute, but the disclosure is not limited thereto, and the time for obtaining temperature pattern information may vary. In addition, when the turning on and off of the microwave generating device 110 is repeated periodically, the processor 140 may obtain temperature pattern information for a period of time during which the microwave generating device 110 is turned on and off once. For example, the processor 140 may obtain temperature pattern information for 30 seconds while the processor 140 turns the microwave generating device 110 on for 8 seconds and immediately turns the microwave generating device 110 off for 22 seconds. The processor 140 may identify the time during which the on/off of the microwave generating device 110 is completed once as the minimum time to obtain temperature pattern information.

However, the disclosure is not limited thereto, and the processor 140 may identify a time longer than the time for completing turn on/off of the microwave generating device 110 once, as the time for obtaining temperature pattern information. For example, the processor 140 may identify the time for completing turn on/off of the microwave generating device 110 twice, as the time for obtaining temperature pattern information. The processor 140 may operate adaptively. For example, the processor 140 may obtain first temperature pattern information for a time period during which turn on/off of the microwave generating device 110 is completed once, and identify the type of container by inputting the first temperature pattern information into a neural network model. However, when the type of container is not clearly identified using the first temperature pattern information, the processor 140 may obtain second temperature pattern information for a time period during which turn on/off of the microwave generating device 110 is completed once more after turn on/off of the microwave generating device 110 is completed once, and identify the type of container by inputting the second temperature pattern information into the neural network model.

The temperature pattern information may include a temperature pattern when the microwaves are not output at certain intervals.

The temperature pattern information may store only one temperature pattern. In this case, the temperature pattern information may include information about the one temperature pattern and a time interval during which microwaves are output in the temperature pattern and a time interval during which microwaves are not output. For example, the processor 140 may obtain six thermal images through the thermal imaging camera 120 at a five-second interval during a 30-second period of microwave output, and obtain six thermal images through the thermal imaging camera 120 at a five-second interval during a subsequent 30-second period of no microwave output. The processor 140 may identify a temperature pattern from the 12 thermal images, and obtain temperature pattern information including the temperature pattern and information about microwave output at each time point in the temperature pattern.

The processor 140 may obtain temperature pattern information at preset time intervals, input the temperature pattern information obtained at the preset time intervals into a neural network model to obtain a plurality of probability values corresponding to each of a plurality of container types, and when the largest probability value among the plurality of probability values is equal to or greater than a preset value, identify a type corresponding to the largest probability value as the container type.

For example, the processor 140 may input the temperature pattern information obtained during the first one minute into a neural network model to obtain a probability value of 0.2 that the container is ceramic, a probability value of 0.1 that the container is paper, and a probability value of 0.7 that the container is steel. Here, when the largest probability value of 0.7 is equal to or greater than the preset probability value of 0.7, the processor 140 may identify the container as steel. When the preset probability value is 0.8 and thus, the largest probability value of 0.7 is less than the preset probability value of 0.8, the processor may input the temperature pattern information obtained during the one-minute period immediately following the first one minute into the neural network model to identify the type of container. In this case, since the second temperature pattern information refers to a state heated through microwaves for a total of 2 minutes, it may be easier to identify the type of container than the temperature pattern information for the first one minute.

When the type of container is a preset type corresponding to a hazardous material, the processor 140 may output a notification indicating that the container is a hazardous material and control the microwave generating device 110 to stop outputting microwaves, and when the type of container is not a preset type corresponding to a hazardous material, the processor 140 may control the microwave generating device 110 to keep outputting microwaves.

For example, when the type of container is steel, the processor 140 may control the microwave generating device 110 to output a notification that the container is unsuitable for use due to the risk of sparking if the container is continued to be heated, and to stop outputting microwaves. When the type of container is not hazardous, such as ceramic, the processor 140 may control the microwave generating device 110 to keep outputting microwaves. Here, the non-hazardous container may be any container suitable for use in the electronic apparatus 100. Such an operation may address the problem of risks such as fire occurring even if the user utilizes a container that is unsuitable for use in the electronic apparatus 100.

The electronic apparatus 100 further includes a display, and the processor 140 may identify a type of recommended container corresponding to an operation mode of the electronic apparatus 100, and when the type of container is different from the type of recommended container, may control the display to display the recommended container.

For example, when a porcelain bowl or a heated fan is utilized in a warming operation mode, the heat applied to the food will be transferred to the container, reducing efficiency, and the processor 140 may control the display to recommend a more suitable container for warming.

However, the disclosure is not limited thereto, and the processor 140 may also identify the type of container, and control the display to display an operation mode of the electronic apparatus 100 corresponding to the type of container.

The electronic apparatus 100 further includes a user interface, and when a user command for controlling the electronic apparatus 100 is received through the user interface, the processor 140 may control the microwave generating device 110 to output microwaves to the cavity for a preset time at a preset output power level to identify the type of container, prior to operating in response to the user command.

For example, when a defrost command is received, the processor 140 may control the microwave generating device 110 to output microwaves at 180 W for 20 seconds to identify the type of container, prior to a defrost operation corresponding to the defrost command. Here, the 20 seconds and 180 W may be independent of the defrost operation. The processor 140 may control the microwave generating device 110 to output microwaves at 180 W for 20 seconds to identify the type of container regardless of which operation command is received. However, the disclosure is not limited thereto, and the minimum time and minimum power output for identifying the type of container before operating in response to a user command may be changed in various ways.

The processor 140 may identify the type of container for a preset period of time, and when the type of container is not a preset type corresponding to a hazardous material, control the microwave generating device 110 based on the operation mode of the electronic apparatus 100 in response to a user command. In the example described above, when a warming command is received, the processor 140 may control the microwave generating device 110 to output microwaves at 180 W for 20 seconds before initiating a warming operation to identify the type of container and, when the type of container is not a preset type corresponding to a hazardous material, initiate the warming operation. When the warming command is received, the processor 140 may control the microwave generating device 110 to output microwaves at 180 W for 20 seconds before initiating the warming operation to identify the type of container, and when the type of container is a preset type corresponding to a hazardous material, output a notification indicating that the container is a hazardous material, and stop outputting microwaves.

The processor 140 may obtain a first temperature pattern of the container based on a plurality of first thermal images, obtain a second temperature pattern of the container based on a plurality of second thermal images, obtain temperature pattern information of the container including information about whether microwaves are output, the first temperature pattern of the container, and the second temperature pattern of the container, and identify the type of container by inputting the temperature pattern information of the container into a neural network model.

The electronic apparatus 100 further includes a heater, and when the type of container is unsuitable for use in the heater, may output a usage notification regarding the heater to the user.

For example, when a user command for using an oven function is received, the processor 140 may control the microwave generating device 110 to output microwaves to the cavity which is an internal space of the electronic apparatus 100, obtain a first temperature pattern of the container based on a plurality of first thermal images, obtain a second temperature pattern of the container based on a plurality of second thermal images, obtain temperature pattern information including information about whether microwaves are output, the first temperature pattern of the container and the second temperature pattern of the container, identify the type of container by inputting the temperature pattern information into a neural network model, and when the type of the container is a container that is not heat-resistant glass that is difficult to withstand high temperatures or is covered with vinyl, output a notification indicating that the container may catch fire, and stop the operation of the heater.

Meanwhile, a function related to artificial intelligence according an embodiment may be operated through the processor 140 and the memory 130.

The processor 140 may consist of one or more processors. In this case, one or more processors may be processors such as CPU, AP, or DSP, dedicated graphics processors such as GPU or Vision Processing Unit (VPU), or dedicated artificial intelligence processors such as NPU.

One or more processors control input data to be processed according to predefined operation rules or artificial intelligence models stored in the memory 130. When one or more processors are dedicated artificial intelligence processors, the dedicated artificial intelligence processors may be designed with a hardware structure specialized for processing an artificial intelligence model. The predefined operation rules or artificial intelligence models are characterized by being created through learning.

Here, “being created through learning” means that the artificial intelligence model is learned using a large number of learning data by a learning algorithm and thus, predefined operation rules or artificial intelligence are set to perform the desired characteristics (or purpose). This learning may be accomplished in the device itself that performs artificial intelligence according to the disclosure, or may be accomplished through a separate server and/or system. Examples of learning algorithms include, but are not limited to, supervised learning, unsupervised learning, semi-supervised learning, or reinforcement learning.

An artificial intelligence model may consist of a plurality of neural network layers. Each of the plurality of neural network layers has a plurality of weight values, and neural network calculation is performed through calculation between the calculation result of the previous layer and the plurality of weights. The plurality of weights of the plurality of neural network layers may be optimized by the learning results of the artificial intelligence model. For example, during the learning process, the plurality of weights may be updated so that loss or cost values obtained from the artificial intelligence model are reduced or minimized.

The artificial neural network may include a deep neural network (DNN), for example, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Network (GAN), or Deep Q-Networks, etc., but is not limited thereto.

The neural network model for identifying the type of container may be a model that has learned the temperature pattern information and the type of container. Here, the temperature pattern information may include at least one temperature pattern or whether microwaves corresponding to each of at least one temperature pattern are output. During the training process, the input data of the neural network model may be the temperature pattern information and the output data may be the type of container.

However, the disclosure is not limited thereto, and the data for training the neural network model may vary. For example, in addition to the temperature pattern information, the input data for the neural network model during the training process may further include at least one of an ambient temperature of the electronic apparatus 100, an operation mode of the electronic apparatus 100, or an output power level of the microwave generating device 110. During the training process, the output data of the neural network model may be the type of container.

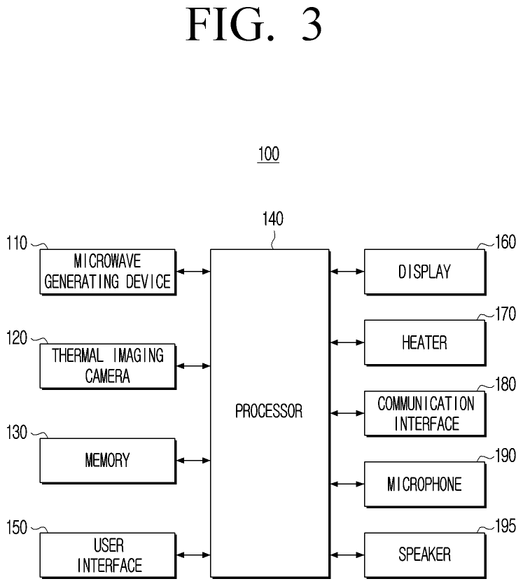

FIG. 3 is a block diagram illustrating detailed configuration of the electronic apparatus 100 according to an embodiment. The electronic apparatus 100 may include the microwave generating device 110, the thermal imaging camera 120, the memory 130, and the processor 140. Referring to FIG. 3, the electronic apparatus 100 may further include a user interface 150, a display 160, a heater 170, a communication interface 180, a microphone 190, and a speaker 195. The components shown in FIG. 3 that overlap with those shown in FIG. 2 will not be described in detail.

The user interface 150 may be implemented as a button, a touch pad, a mouse, a keyboard, etc., or may be implemented as a touch screen that can also perform a display function and a manipulation input function. Here, the button may be a various types of buttons such as a mechanical button, a touch pad, a wheel, etc. formed in any arbitrary area such as front, side, back, etc.

The display 160 is configured to display an image, and may be implemented as various types of displays, such as liquid crystal displays (LCDs), organic light emitting diodes (OLEDs) displays, plasma display panels (PDPs), and the like. The display 160 may also include a driving circuit, a backlight unit, and the like, which may be implemented in the form of a-si TFTs, low temperature poly silicon (LTPS) TFTs, organic TFTs (OTFTs), and the like. Meanwhile, the display 160 may be implemented as a touch screen combined with a touch sensor, a flexible display, a three-dimensional (3D) display, and the like.

The heater 170 may be configured to cook food ingredients under the control of the processor 140. For example, the heater 170 may include at least one of a heater for applying heat to food ingredients or a steamer utilized in a cooking process. The heater 170 may be implemented in a form that includes a heater and a fan for circulating heat of the heater. However, the heater 170 is not limited thereto, and the heater 170 may be in any configuration that is capable of cooking food ingredients.

The communication interface 180 is configured to perform communication with various types of external devices according to various types of communication methods. For example, the electronic apparatus 100 may perform communication with each of a user device 2 or a server 3.

The communication interface 180 may include a Wi-Fi module, a Bluetooth module, an infrared communication module, a wireless communication module, and the like. Here, each communication module may be implemented in the form of at least one hardware chip.

The Wi-Fi module and the Bluetooth module perform communication using a Wi-Fi method and a Bluetooth method, respectively. When using a Wi-Fi module or a Bluetooth module, various connection information such as SSID and session keys are first transmitted and received, and various information can be transmitted and received after establishing communication connection using this. The infrared communication module performs communication according to an infrared Data Association (IrDA) communication technology which transmits data wirelessly over a short distance using infrared rays between optical light and millimeter waves.

The wireless communication module includes at least one communication chip that performs communication according to various wireless communication standards, such as Zigbee, 3rd Generation (3G), 3rd Generation Partnership Project (3GPP), Long Term Evolution (LTE), LTE advanced (LTE-A), 4th Generation (4G), 5th Generation (5G), etc.

The communication interface 180 may include a wired communication interface such as HDMI, DP, Thunderbolt, USB, RGB, D-SUB, DVI, etc.

In addition, the communication interface 180 may include at least one of a Local Area Network (LAN) module, an Ethernet module or a wired communication module that performs communication using a pair cable, a coaxial cable or an optical fiber cable.

The microphone 190 is configured to receive sound and convert it into an audio signal. The microphone 190 is electrically connected to the processor 140, and may receive sound under the control of the processor 140.

For example, the microphone 190 may be integrally formed in the direction of the top, front, side, etc. of the electronic apparatus 100. The microphone 190 may be formed on a remote controller, etc. that is separate from the electronic apparatus 100. In this case, the remote controller may receive sound through the microphone 190, and provide the received sound to the electronic apparatus 100.

The microphone 190 may include various components such as a microphone that collects analog sound, an amplification circuit that amplifies the collected sound, an A/D conversion circuit that samples the amplified sound and converts it into a digital signal, a filter circuit that removes noise components from the converted digital signal, etc.

Meanwhile, the microphone 190 may be implemented in the form of a sound sensor, and may be configured in any way that is capable of collecting sound.

The processor 140 may also receive a user command through the microphone 190.

The speaker 195 is configured to output not only various audio data processed by the processer 150 but also various notification sounds, voice messages, etc.

The processor 140 may control the speaker 195 to output sound to announce a usage notification regarding the electronic apparatus 100.

As described above, the electronic apparatus 100 may identify the type of container based on the temperature pattern information inside the electronic apparatus 100 and output a notification to the user to improve the convenience of the user.

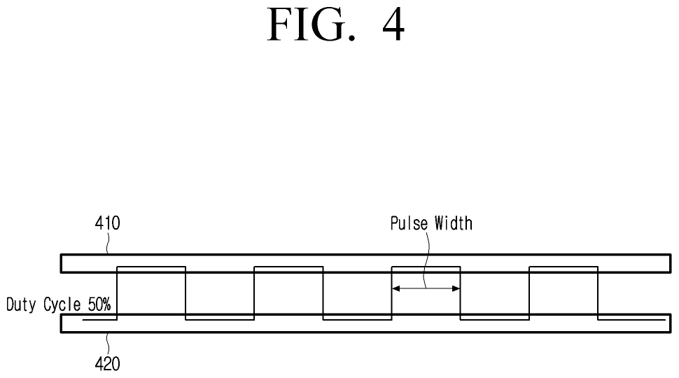

Hereinafter, the operation of the electronic apparatus 100 will be described in greater detail with reference to FIGS. 4 to 13. In FIGS. 4 to 13, individual embodiments will be described for convenience of explanation. However, the individual embodiments of FIGS. 4 to 13 may be practiced in any combination.

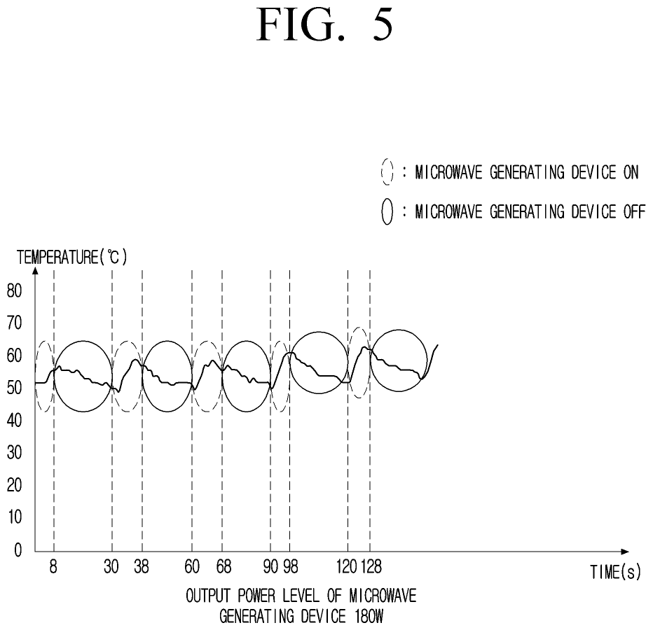

FIGS. 4 and 5 are views provided to explain a temperature pattern in response to control of the microwave generating device 110 according to an embodiment.

The processor 140 may control the microwave generating device 110 based on a pulse width modulation (PWM) control signal. For example, the processor 140 may provide a PWM control signal to the microwave generating device 110 to turn on or turn off the microwave generating device 110, as shown in FIG. 4.

The microwave generating device 110 may be turned on in a high level region 410 and turned off in a low level region 420 in the PWM control signal.

While FIG. 4 shows a duty cycle of 50% for convenience of explanation, the disclosure is not limited thereto, and the duty cycle may vary. For example, the duty cycle may be determined based on an output power level of the microwave generating device 110. For instance, when the output power level of the microwave generating device 110 is 450 W, the waveform may be high level for 18 second and low level for 12 seconds, and such a waveform may be repeated. When the output power level of the microwave generating device 110 is 180 W, the waveform may be high level for 8 seconds and low level for 22 seconds, and such a waveform may be repeated.

The processor 140 may obtain temperature pattern information based on the PWM control signal and the information obtained through the thermal imaging camera 120. Here, the temperature pattern information may include output information of the microwaves and a temperature pattern of the container disposed within the cavity.

For convenience of explanation, FIG. 5 shows a temperature pattern of a container, assuming that the output power level of the microwave generating device 110 is 180 W and the PWM control signal has high level for 8 seconds and low level for 22 seconds.

The processor 140 may control the microwave generating device 110 based on the PWM control signal with high level for 8 seconds and low level for 22 seconds. Accordingly, the microwave generating device 110 may be turned on for 8 seconds, immediately turned off for 22 seconds, and this operation may be repeated.

The processor 140 may obtain a plurality of first thermal images through the thermal imaging camera 120 during the 8 seconds when microwaves are output. The processor 140 may obtain a temperature pattern during the period of microwave output from the plurality of first thermal images, and the temperature pattern may be in a state in which the temperature is increasing as shown in the dashed circle in FIG. 5. The processor 140 may obtain a plurality of second thermal images through the thermal imaging camera 120 during the 22 seconds when no microwaves are output. The processor 140 may obtain a temperature pattern during the period of no microwave output, and the temperature pattern may be in a state in which the temperature is decreasing as shown in the solid circles in FIG. 5.

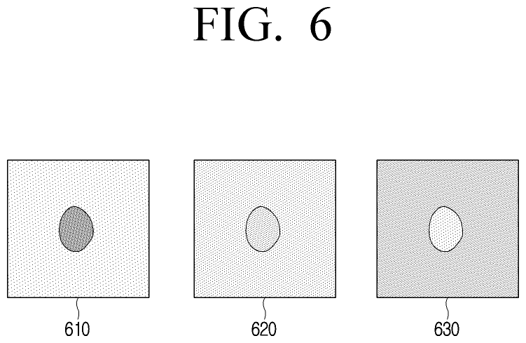

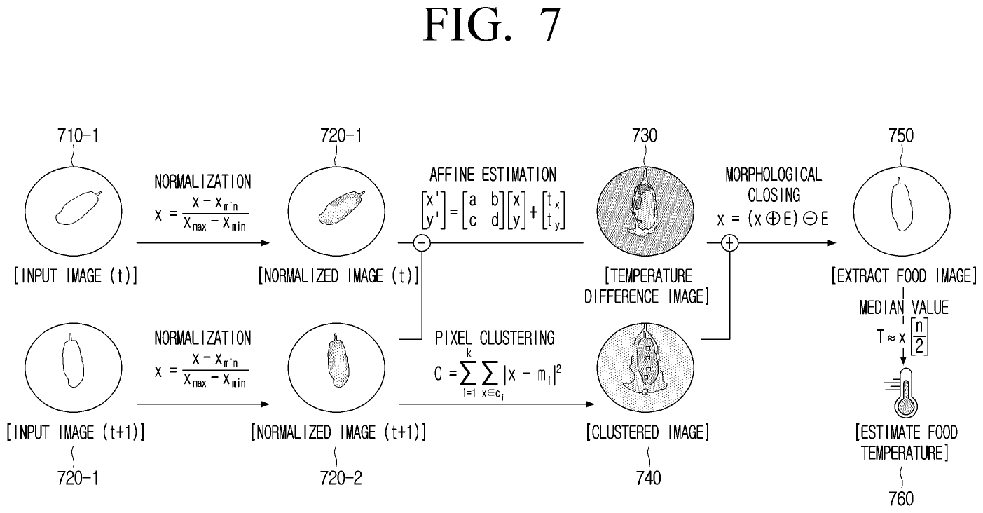

FIGS. 6 and 7 are views provided to explain a method of analyzing a thermal image according to an embodiment.

The processor 140 may identify a container within the cavity based on information obtained from the thermal imaging camera 120. For example, the processor 140 may obtain a plurality of thermal images 610, 620, 630 through the thermal imaging camera 120 at preset time intervals, as shown in FIG. 6. Here, the plurality of thermal images may be in a state in which temperature is changing, for example, by microwaves, and the degree of temperature change varies from region to region, as shown in FIG. 6, due to a difference in temperature change between the container and areas outside of the container (e.g., air or a floor not elevated above the container).

The processor 140 may identify a container based on the plurality of thermal images, and may identify a temperature pattern of the container. For example, the processor 140 may preprocess the plurality of thermal images using an erosion algorithm, and identify the container using a k-means clustering algorithm. For example, the processor 140 may normalize each of the thermal image at time t and the thermal image at time t+1, as shown in FIG. 7, obtain a temperature difference image from the normalized thermal image at time t and the normalized thermal image at time t+1, pixel-cluster the thermal image at time t+1 to obtain a clustered image, and identify a region of the container based on the temperature difference image and the clustered image. In this case, the container and the food in the container may have similar temperature patterns and thus, the processor 140 may identify the entire region including the container and the food in the container.

However, the disclosure is not limited thereto, and the processor 140 may identify the temperature pattern of the container in the plurality of thermal images in any number of different ways. For example, the processor 140 may use a neural network model to identify the temperature pattern of the container from the plurality of thermal images. In this case, during the training process, the input data of the neural network model may be the plurality of thermal images, and the output data may be the temperature pattern of the container.

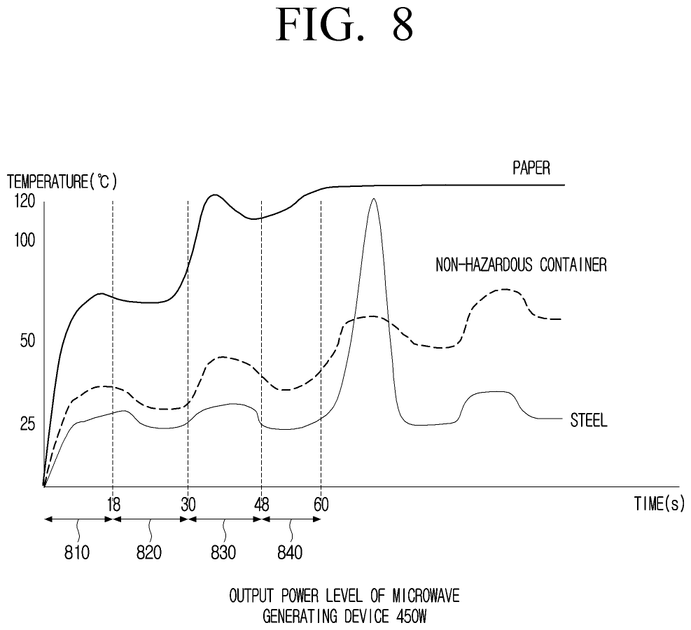

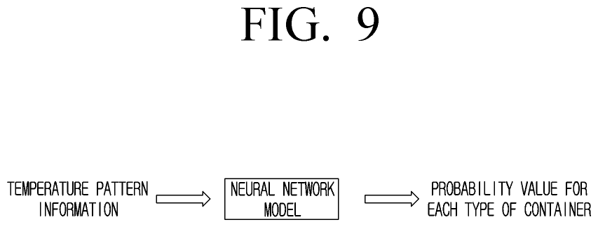

FIGS. 8 and 9 are views provided to explain a temperature pattern based on a type of container and output of a neural network model based on the temperature pattern according to an embodiment.

For convenience of explanation, FIG. 8 illustrates the temperature patterns of various containers, assuming that the output power level of the microwave generating device 110 is 450 W and the PWM control signal has a high level for 18 seconds and a low level for 12 seconds.

The processor 140 may obtain the plurality of first thermal images through the thermal imaging camera 120 while microwaves are output, obtain the plurality of second thermal images through the thermal imaging camera 120 while microwaves are not output, and obtain temperature pattern information including the first temperature pattern of the container obtained based on the plurality of first thermal images and the second temperature pattern of the container obtained based on the plurality of second thermal images. For example, as shown in FIG. 8, the processor 140 may obtain the plurality of first thermal images through the thermal imaging camera 120 during section 810 where microwaves are output and the plurality of second thermal images through the thermal imaging camera 120 during section 820 where microwaves are not output, and obtain temperature pattern information including the first temperature pattern of the container obtained based on the plurality of first thermal images and the second temperature pattern of the container obtained based on the plurality of second thermal images.

The temperature pattern may vary depending on the type of container. For example, as shown in FIG. 8, the temperature of paper rises rapidly in section 810, and as shown in FIG. 9, the processor 140 may input the temperature pattern information of paper into the neural network model to identify that the type of container is paper, and provide a notification that there is a risk of fire.

As shown in FIG. 8, the temperature of non-hazardous container and steel rises at a relatively slower rate than paper in section 810, and the processor 140 may input the temperature pattern information of the non-hazardous container into the neural network model to identify that the type of container is a non-hazardous container, and input the temperature pattern information of steel into the neural network model to identify that the type of container is steel.

However, the neural network model may not be sophisticated, in which case the processor 140 may not be able to clearly distinguish between a non-hazardous container and steel. For example, the processor 140 may input the temperature pattern information of steel into the neural network model to obtain a probability of 0.4 for a non-hazardous container, a probability of 0.4 for steel, and a probability of 0.2 for paper. The temperature pattern information using sections 810 and 820 alone may not clearly identify the type of container. In this case, as shown in FIG. 8, the processor 140 may further obtain a plurality of first thermal images through the thermal imaging camera 120 during section 830 where microwaves are output, further obtain a plurality of second thermal images through the thermal imaging camera 120 during section 840 where microwaves are not output, and update the temperature pattern information based on the further obtained plurality of first thermal images and the further obtained plurality of second thermal images. The processor 140 may re-identify the type of container based on the updated temperature pattern information, and may output a danger notification to the user before the steel sparks.

The neural network model may learn a temperature pattern for each type of container. Once the neural network model is trained, the neural network model may receive temperature pattern information and output a probability value for each type of container, as shown in FIG. 9. When the largest probability value among a plurality of probability values is equal to or greater than a preset value, the processor 140 may identify a type corresponding to the largest probability value as the type of container. However, the disclosure is not limited thereto, and the neural network model may also output the type of container based on the temperature pattern information.

Meanwhile, FIG. 8 describes that temperature pattern information is obtained based on the plurality of thermal images during section 810 where microwaves are output and section 820 interval where microwaves are not output, but the disclosure is not limited thereto. For example, the processor 140 may obtain temperature pattern information based on the plurality of thermal images during section 810 where microwaves are output, and input the temperature pattern information into a neural network model to identify the type of container.

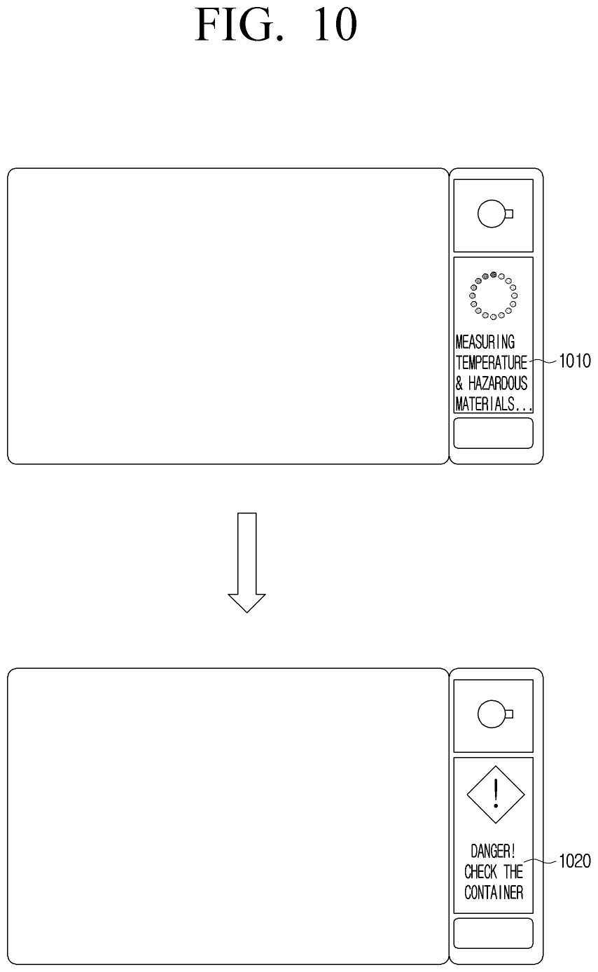

FIG. 10 is a view provided to explain an operation of outputting a notification indicating that a container is a hazardous material according to an embodiment.

When a user command for controlling the electronic apparatus 100 is received through the user interface 150, the processor 140 may control the microwave generating device 110 to output microwaves to the cavity for a preset period of time at a preset output power level to identify the type of container before operating in response to the user command. The processor 140 may control the microwave generating device 110 to output microwaves to the cavity to identify the type of container regardless of the operation mode corresponding to the user command. In this case, the processor 140 may control the display 160 to display a notification 1010, “Measuring temperature & hazardous materials . . . ”, as shown at the top of FIG. 10.

The processor 140 may identify the type of container for a preset period of time, and when the type of container is not a preset type corresponding to a hazardous material, control the microwave generating device based on the operation mode of the electronic apparatus 100 corresponding to the user command.

When the type of container is a preset type corresponding to a hazardous material as shown at the bottom of FIG. 10, the processor 140 may provide a notification 1020, such as “Danger! Check the container”, indicating that the container is a hazardous material, and may control the microwave generating device 110 to stop outputting microwaves.

In FIG. 10, for convenience of explanation, it is illustrated that the processor 140 outputs microwaves for a preset time period regardless of the operation mode corresponding to the user command, but the disclosure is not limited thereto. For example, the processor 140 may output microwaves for a preset time regardless of the operation mode corresponding to the user command, but may extend the time for outputting microwaves when the type of container is not identified while microwaves are output.

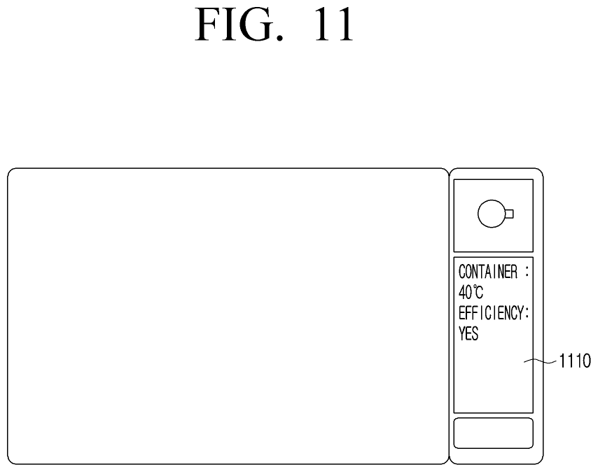

FIG. 11 is a view provided to explain an operation of guiding efficiency of a container according to an embodiment.

As shown in FIG. 11, the processor 140 may identify the type of a recommended container corresponding to the operation mode of the electronic apparatus 100, and when the identified type of container is the same as the type of the recommended container, provide a notification 1110 indicating the temperature and efficiency of the container.

When the identified type of container is different from the type of the recommended container, the processor 140 may control the display 150 to display the recommended container.

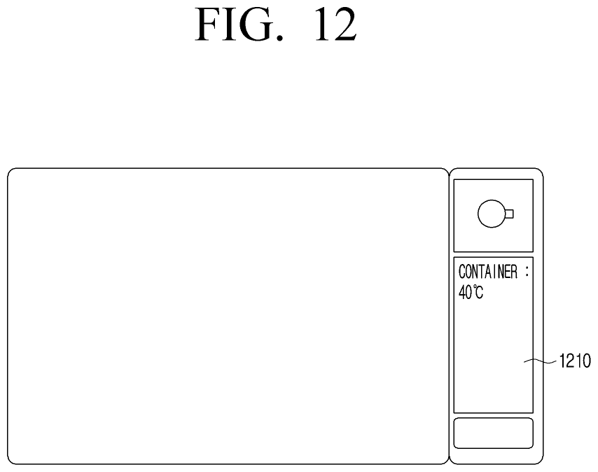

FIG. 12 is a view provided to explain an operation of guiding a temperature of a container according to an embodiment.

After completing an operation in the operation mode corresponding to the user command, the processor 140 may provide the temperature of the container as a notification. For example, after completing an operation in the operation mode corresponding to the user command, the processor 140 may provide a notification 1210 such as “Container: 40° C.” Such an operation may prevent the user from having a risk of getting burned.

However, the disclosure is not limited thereto, and the processor 140 may provide the temperature of the container as a notification even before completing the operation in the operation mode corresponding to the user command. For example, after performing an operation to identify the type of container, when the type of container is a preset type corresponding to a hazardous material, the processor 140 may output a notification indicating that the container is a hazardous material along with the temperature of the container.

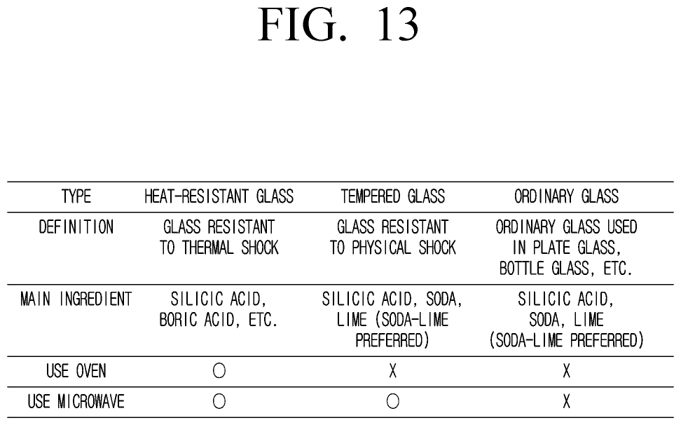

FIG. 13 is a view provided to explain an operation based on a type of glass according to an embodiment.

The processor 140 may distinguish between heat-resistant glass, tempered glass, and general glass even if they are the same glass. This is because the neural network model learns the difference in temperature change from the temperature pattern of each glass.

When the type of container is glass, the processor 140 may identify that the container is unsuitable for use in a microwave and an oven. When the type of container is glass, the processor 140 may limit the use of the microwave generating device 110 and the heater 170.

When the type of container is heat-resistant glass, the processor 140 may identify that the container is suitable for use in a microwave and an oven. When the type of container is heat-resistant glass, the processor 140 may perform cooking by controlling the microwave generating device 110 or the heater 170.

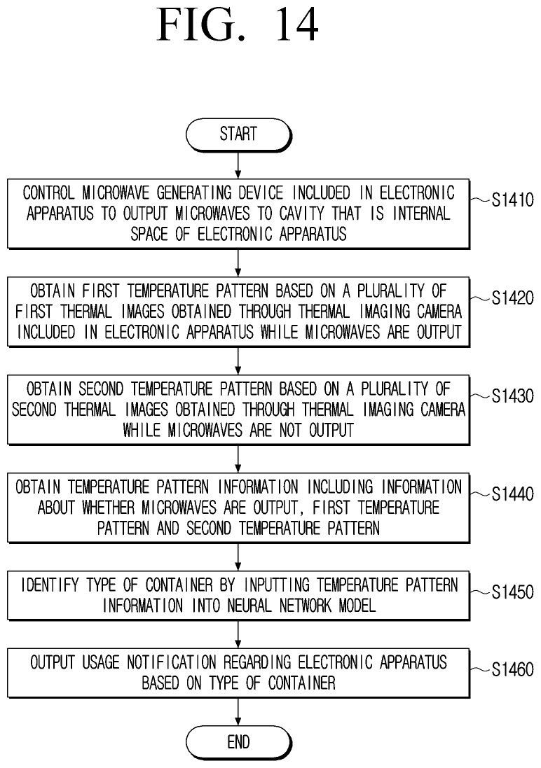

FIG. 14 is a flowchart provided to explain a controlling method of an electronic apparatus according to an embodiment.

Firstly, a microwave generating device included in the electronic apparatus is controlled to output microwaves to a cavity, an internal space of the electronic apparatus (S1410), and a first temperature pattern is obtained based on a plurality of first thermal images obtained through a thermal imaging camera included in the electronic apparatus while outputting microwaves (S1420). A second temperature pattern is obtained based on a plurality of second thermal images obtained through a thermal imaging camera while not outputting microwaves (S1430). Temperature pattern information including information about whether microwaves are output, the first temperature pattern, and the second temperature pattern is obtained (S1440). A type of container is identified by inputting the temperature pattern information into a neural network model (S1450). A usage notification regarding the electronic apparatus is output based on the type of container (S1460).

Step S1440 of obtaining temperature pattern information may include obtaining temperature pattern information at preset time intervals, and step S1450 of identifying may include obtaining a plurality of probability values corresponding to a plurality of types of container by inputting the temperature pattern information obtained at preset time intervals into a neural network model, and when the largest probability value among the plurality of probability values is equal to or greater than a preset value, identifying a type corresponding to the largest probability as the type of container.

In addition, step S1460 of outputting a usage notification may include, when the type of container is a preset type corresponding to a hazardous material, outputting a notification indicating that the container is a hazardous material and controlling the microwave generating device to stop outputting microwaves, and when the type of container is not a preset type corresponding to a hazardous material, controlling the microwave generating device to keep outputting microwaves.

The method may further include identifying a type of a recommended container corresponding to an operation mode of the electronic apparatus and, when the type of container is different from the type of the recommended container, displaying the recommended container.

In addition, step S1410 of outputting microwaves may include, when a user command for controlling the electronic apparatus is received, controlling the microwave generating device to output microwaves to the cavity for a preset time at a preset output power level to identify the type of container, prior to operating in response to the user command.

Step S1450 of identifying may further include identifying the type of container for a preset time period, and the controlling method may further include, when the type of container is not a preset type corresponding to a hazardous material, controlling the microwave generating device based on an operation mode of the electronic apparatus corresponding to the user command.

In addition, step S1420 of obtaining a first temperature pattern may include obtaining the first temperature pattern of the container based on the plurality of first thermal images, step S1430 of obtaining a second temperature pattern may include obtaining the second temperature pattern of the container based on the plurality of second thermal images, step S1440 of obtaining temperature pattern information may include obtaining the temperature pattern information of the container including information about whether microwaves are output, the first temperature pattern of the container, and the second temperature pattern of the container, and step S1450 of identifying may include inputting the temperature pattern information of the container into a neural network model to identify the type of container.

The controlling method may further include, when the type of container is a type of container that is unsuitable for use in a heater included in the electronic apparatus, outputting a usage notification regarding the heater.

According to the above-described various embodiments of the disclosure, the electronic apparatus may identify the type of container based on the temperature pattern information inside the electronic apparatus and output a notification to the user to improve the convenience of the user.

Meanwhile, according to an embodiment, the above-described various embodiments may be implemented as software including instructions stored in machine-readable storage media, which can be read by machine (e.g.: computer). The machine refers to a device that calls instructions stored in a storage medium, and can operate according to the called instructions, and the device may include an electronic device according to the aforementioned embodiments (e.g.: electronic apparatus (A)). In case an instruction is executed by a processor, the processor may perform a function corresponding to the instruction by itself, or by using other components under its control. An instruction may include a code that is generated or executed by a compiler or an interpreter. The machine-readable storage medium may be provided in a form of a non-transitory storage medium. Here, the term “non-transitory” means that the storage medium is tangible without including a signal, and does not distinguish whether data are semi-permanently or temporarily stored in the storage medium.

In addition, according to an embodiment, the above-described methods according to the various embodiments may be included and provided in a computer program product. The computer program product may be traded as a product between a seller and a purchaser. The computer program product may be distributed in a form of a storage medium (for example, a compact disc read only memory (CD-ROM)) that may be read by the machine or online through an application store (for example, PlayStore™). In case of the online distribution, at least a portion of the computer program product may be at least temporarily stored in a storage medium such as a memory of a server of a manufacturer, a server of an application store, or a relay server or be temporarily generated.

In addition, according to an embodiment, the above-described various embodiments are may be implemented in a recording medium that can be read by a computer or a similar device using software, hardware, or a combination thereof. In some cases, embodiments described herein may be implemented by a processor itself. According to software implementation, embodiments, such as procedures and functions described, may be implemented as separate software modules. Each of the software modules may perform one or more functions and operations described in this disclosure.

Meanwhile, computer instructions for performing processing operations of devices according to the above-described various embodiments may be stored in a non-transitory computer-readable medium. When being executed by a processor of a device, the computer instructions stored in such a non-transitory computer-readable medium allows the device to perform processing operations in the device according to the above-described various embodiments. The non-transitory computer-readable medium refers to a medium that stores data semi-permanently and can be read by a device, rather than a medium that stores data for a short period of time, such as registers, caches, and memories. Examples of the non-transitory computer-readable medium may include CD, DVD, hard disk, Blu-ray disk, USB, memory card, or ROM, for example, but the disclosure is not limited thereto.

In addition, the components (for example, modules or programs) according to various embodiments described above may include a single entity or a plurality of entities, and other sub-components may be further included in the various embodiments. Some components (e.g., modules or programs) may be integrated into one entity and perform the same or similar functions performed by each corresponding component prior to integration. Operations performed by the modules, the programs, or the other components according to the diverse embodiments may be executed in a sequential manner, a parallel manner, an iterative manner, or a heuristic manner, or at least some of the operations may be performed in a different order, or other operations may be added.

Although preferred embodiments of the disclosure have been shown and described above, the disclosure is not limited to the embodiments described above, and various modifications may be made by one of ordinary skill in the art without departing from the spirit of the disclosure.

What is claimed is:

1. An electronic apparatus comprising:
a microwave generating device;
a thermal imaging camera;
one or more processors; and
memory storing instructions that, when executed by the one or more processors, cause the electronic apparatus to:
control the microwave generating device to output microwaves into a cavity that is an internal space of the electronic apparatus;
obtain a first temperature pattern, based on a plurality of first thermal images obtained through the thermal imaging camera, based on the microwaves being output;
obtain a second temperature pattern, based on a plurality of second thermal images obtained through the thermal imaging camera, based on the microwaves not being output;
obtain temperature pattern information comprising information about whether the microwaves are output, the first temperature pattern, and the second temperature pattern;
identify a type of a container by inputting the temperature pattern information to a first neural network model; and
output a first usage notification regarding the electronic apparatus based on the type of the container.

2. The electronic apparatus as claimed in claim 1, wherein the one or more processors are configured to execute the instructions to cause the electronic apparatus to:
obtain the temperature pattern information at preset time intervals;
obtain a plurality of probability values corresponding to a plurality of types of container respectively by inputting the temperature pattern information obtained at the preset time intervals to the first neural network model; and
based on a largest probability value of the plurality of probability values being equal to or greater than a preset value, identify a first type corresponding to the largest probability value as the type of the container.

3. The electronic apparatus as claimed in claim 1, wherein the one or more processors are configured to execute the instructions to cause the electronic apparatus to:
based on the type of the container being a preset type of one or more preset types corresponding to one or more hazardous materials, output a notification indicating that the container is hazardous, and control the microwave generating device to stop outputting the microwaves; and
based on the type of the container not being the preset type, control the microwave generating device to keep outputting the microwaves.

4. The electronic apparatus as claimed in claim 1, further comprising a display,
wherein the one or more processors are configured to execute the instructions to cause the electronic apparatus to:
identify a second type of a recommended container corresponding to an operation mode of the electronic apparatus; and
based on the type of the container being different from the second type, control the display to indicate the second type.

5. The electronic apparatus as claimed in claim 1, further comprising a user interface,
wherein the one or more processors are configured to execute the instructions to cause the electronic apparatus to, based on a user command for controlling the electronic apparatus being received through the user interface, output the microwaves to the cavity by controlling the microwave generating device for a preset time at a preset output power level to identify the type of the container, prior to operating in response to the user command.

6. The electronic apparatus as claimed in claim 5, wherein the one or more processors are configured to execute the instructions to cause the electronic apparatus to:
identify the type of the container for the preset time; and
based on the type of the container not being a preset type of one or more preset types corresponding to one or more hazardous materials, control the microwave generating device based on an operation mode of the electronic apparatus corresponding to the user command.

7. The electronic apparatus as claimed in claim 1, wherein the first neural network model is trained based on first input data comprising a first plurality of temperature patterns and first output data comprising a plurality of types of containers.

8. The electronic apparatus as claimed in claim 7, wherein the first input data further comprises at least one of a plurality of ambient temperatures, a plurality of operation modes, or a plurality of output power levels.

9. The electronic apparatus as claimed in claim 7, wherein the one or more processors are configured to execute the instructions to cause the electronic apparatus to obtain the temperature pattern information from a second neural network model, and
wherein the second neural network model is trained based on second input data comprising a plurality of thermal images and second output data comprising a second plurality of temperature patterns.

10. The electronic apparatus as claimed in claim 1, further comprising a heater,
wherein the one or more processors are configured to execute the instructions to cause the electronic apparatus to, based on the type of the container being a second type unable to use the heater, output a second usage notification regarding the heater.

11. A controlling method of an electronic apparatus, comprising:
outputting microwaves into a cavity that is an internal space of the electronic apparatus by controlling a microwave generating device included in the electronic apparatus;
obtaining a first temperature pattern, based on a plurality of first thermal images obtained through a thermal imaging camera included in the electronic apparatus, based on the microwaves being output;
obtaining a second temperature pattern, based on a plurality of second thermal images obtained through the thermal imaging camera, based on the microwaves not being output;
obtaining temperature pattern information comprising information about whether the microwaves are output, the first temperature pattern, and the second temperature pattern;
identifying a type of a container by inputting the temperature pattern information to a first neural network model; and
outputting a first usage notification regarding the electronic apparatus based on the type of the container.

12. The controlling method as claimed in claim 11, wherein the obtaining the temperature pattern information comprises obtaining the temperature pattern information at preset time intervals; and
wherein the identifying the type of the container comprises:
obtaining a plurality of probability values corresponding to a plurality of types of container respectively by inputting the temperature pattern information obtained at the preset time intervals to the first neural network model; and
based on a largest probability value of the plurality of probability values being equal to or greater than a preset value, identifying a first type corresponding to the largest probability value as the type of the container.

13. The controlling method as claimed in claim 11, wherein the outputting the usage notification comprises:
based on the type of the container being a preset type of one or more preset types corresponding to one or more hazardous materials, outputting a notification indicating that the container is hazardous, and controlling the microwave generating device to stop outputting the microwaves; and
based on the type of the container not being the preset type corresponding to a hazardous material, controlling the microwave generating device to keep outputting the microwaves.

14. The controlling method as claimed in claim 11, further comprising:
identifying a second type of a recommended container corresponding to an operation mode of the electronic apparatus; and
based on the type of the container being different from the second type, indicating the second type.

15. The controlling method as claimed in claim 11, wherein the outputting the microwaves comprises, based on a user command for controlling the electronic apparatus being received through a user interface, outputting the microwaves to the cavity by controlling the microwave generating device for a preset time at a preset output power level to identify the type of the container, prior to operating in response to the user command.

16. The controlling method as claimed in claim 15, wherein the identifying the type of the container comprises identifying the type of the container for the preset time, and
wherein the controlling method further comprises, based on the type of the container not being a preset type of one or more preset types corresponding to one or more hazardous materials, controlling the microwave generating device based on an operation mode of the electronic apparatus corresponding to the user command.

17. The controlling method as claimed in claim 11, wherein the first neural network model is trained based on first input data comprising a first plurality of temperature patterns and first output data comprising a plurality of types of containers.

18. The controlling method as claimed in claim 17, wherein the first input data further comprises at least one of a plurality of ambient temperatures, a plurality of operation modes, or a plurality of output power levels.

19. The controlling method as claimed in claim 11, further comprising, based on the type of the container being a second type unable to use a heater, output a second usage notification regarding the heater.

20. A non-transitory computer-readable recording medium having instructions recorded thereon, that, when executed by one or more processors, cause the one or more processors to:
control a microwave generating device to output microwaves into a cavity that is an internal space of an electronic apparatus;
obtain a first temperature pattern based on a plurality of first thermal images obtained through a thermal imaging camera based on the microwaves not being output;
obtain a second temperature pattern based on a plurality of second thermal images obtained through the thermal imaging camera based on the microwaves not being output;
obtain temperature pattern information comprising information about whether the microwaves are output, the first temperature pattern, and the second temperature pattern;
identify a type of a container by inputting the temperature pattern information to a first neural network model; and
output a first usage notification regarding the electronic apparatus based on the type of the container.
